(19) United States
(12) Patent Application Publication
(10) Pub. No.: US 2019/0121147 A1
(43) Pub. Date: Apr. 25, 2019

(54) OPTICAL SYSTEM FOR THE 3D EMPHASIZING OF LIGHT EFFECTS

(71) Applicant: Patrizio PISANI, ROMA (RM) (IT)

(72) Inventor: Patrizio PISANI, ROMA (RM) (IT)

(21) Appl. No.: 16/095,105

(22) PCT Filed: May 15, 2017
(86) PCT No.: PCT/EP2017/061579

§ 371 Date: Oct. 19, 2018

(30) Foreign Application Priority Data
May 19, 2016 (IT) 102016000051638

(51) Int. Cl. G02B 27/22; F21V 17/10; H04L 29/08

(52) U.S. Cl. CPC G02B 27/22; F21Y 2115/10; H04L 67/141; F21V 17/10

(57) ABSTRACT

A passive optical unit for emphasizes light effects generated on the screen or on the LED of a portable processing device. The optical unit includes a base and an optical guide. The base can be provided with a gripper connecting the optical unit to the portable processing device. The optical guide can have two differentiated branches for the screen and the LED, which by converging on the upper part of the optical guide create an optical mixing effect between the screen and the LED. On the base of the optical guide, material inserts can be inserted that can be detected by the touch sensor of the screen of the portable device. By using such points of contact combined with the information known beforehand, the device can be configured to determine the exact position of the screen where to represent the image to be optically coupled with the optical guide.

### FIELD OF THE ART

The present invention refers to the field of optical systems for the diffusion of luminous information.

In detail, the present invention regards a passive optical system that allows making the luminous information, that can be generated by the screen or by an LED of a common portable communication and processing device (as a non-limiting example, a smartphone or a tablet), three-dimensional.

In detail, the present invention regards a system for identifying the position of the optical system when abutted against the screen provided with touch sensor of the processing device. In detail, with the same method, the electronic device can automatically determine an identification code of the optical system that it can use in complex systems for interaction between devices that interact with each other by means of the digital network.

### PRIOR ART

Since human prehistory, light and fire have represented a fundamental symbol, also in the birth of religious thought.

“Homo Religiosus” was born looking at the light of the sun and starts. The first certain traces date back to 9500 BC.

In the ancient Indo-European language, the word “deiwo” (dei+ root) signifies “to shine”, “to give light”.

Anthropological research has shown that holy symbols have a fundamental role in the necessary mediation between “human and supernatural”.

In this context, light immediately assumed the role of sacred symbol of the supernatural. In all the great religions, light assumes an essential role in the symbols and rites.

In holy Christian texts, it is a symbol of the presence of God, in the Pentecost it is the symbol of the Holy Spirit, while the Paschal candle is the light of Christ that illuminates the church (and these are only a few of the examples regarding Christianity).

In Buddhism, Buddha is represented with two types of light: the light that irradiates directly from his body, which represents the intimately divine spirit thereof, and the light that irradiates from a flame placed on the head, that represents the transmission of the divine to humanity.

In Islam, Surat 24 at passage 35 is dedicated to light as symbol of God, and light is often associated with the Koran itself.

In Hinduism, in the Upanishads Brahma and Atman are identified with light. Light is present in many texts and disciplines dedicated to meditation.

This symbolism of light is anthropologically encoded in the human being, and it is associated with ancestral rituals.

In many group rites, even secular rites, light always has an essential role, even as a symbol of participation in the rite itself: at a concert, for example, where the spectators light a lighter, or in a religious procession where everyone carries a candle.

Very often, one seeks to substitute a light (e.g. of a candle) by using smartphone APPs, but the result that is obtained is always one-dimensional, quite different from the splendor of a true source of votive light.

There are technologies that allow associating electronic lights controlled by means of Bluetooth or WiFi, but these are limited by the fact that they are separate electronic objects, which require power supply, with non-negligible cost and above all they must be connected to the cell phone with procedures that cannot be readily carried out, and are too complicated to be used by all people. If, then, it is desired to create groups of users who incidentally share the same lights (e.g. in order to be synchronized to have the same color during a religious event), the procedure would be complex (if not impossible), if such contingent event was not provided over all the APPs associated with external light sources owned by the single individuals.

The present invention overcomes these limits with a low-cost passive optical unit that makes the light effects, that can be generated by a portable device such as a smartphone or a tablet, three-dimensional.

In addition, by means of a system for encoding the passive optical unit based on the use of material detectable by the capacitive screen of the portable device, the present invention allows simplifying, as much as possible, both the process of interconnection of the device to remote services (e.g. a web radio) and the process of creation of groups of interconnected users (e.g. for an audio conference or for a religious procession), adding to all these services a light coding level that increases the user-experience and the communication opportunities.

### SUMMARY OF THE INVENTION

According to the present invention, an optical unit is attained which simply and intuitively allows making luminous messages, generated by a flat screen or by a LED normally present in portable devices such as smartphones and tablets, three-dimensional. In addition, the present invention allows, in a simple manner, creating complex scenarios of devices connected online which exchange information, also luminous information, without the user having to carry out complex procedures which most of the time actually become a limit for technology application.

Another important advantage of the present invention is that all that described above can be obtained by means of a simple non-electronic unit.

Advantageously, the optical unit (illustrated in FIG. 1 and in various embodiments in FIG. 2) is composed of two functional sections: a base, made of any material that is not necessarily able to transmit light, and an optical guide, made of vitreous or plastic material, capable of transmitting visible light. It is obvious that the two functional parts can be made on a single mold of material adapted to transmit light; in this case the base can be made opaque by means of suitable coloring.

The base has the first task of giving mechanical stability to the optical unit, when it is abutted on top of a portable device (e.g. a smartphone or a tablet). The optical guide is integral with the base and traverses it such that it can exhibit at least one face thereof towards the screen or towards the LED of the portable device, generating an optical coupling.

In this manner, an image, static or variable, represented on the screen of the device will be transmitted through the optical guide, which will disperse it and represent it both at the sides and on the top thereof (analogously for the light generated by the LED).

Advantageously, in order to make the optical unit integral with the portable device, the base can be provided with a band (elastic or Velcro) to pass around the portable device.

Advantageously, for the same reason, the base of the optical unit can be provided with a spring gripper which allows the fixing thereof.

Advantageously, the optical guide can generate differentiated effects if provided with parts of different optical dispersion coefficient. For example, the base of the optical guide can have an external circumference with high dispersion (generating multipath facing for the light radiation within the guide), and a central part with minimum dispersion (generating a preferred path towards the top of the guide). In this manner, if one generates an image on the screen, for example with a red ring on the outside and a yellow light at the center, we will obtain the red light as that mainly diffused over the entire surface (also lateral) of the guide, while the yellow color will be mainly diffused from the upper end.

Advantageously, the unit can be provided with an optical guide with two differentiated optical coupling branches, converging on a single terminal branch, functioning as an optical mixer that allows combining the modulated light of the LED of the portable device with that generated on the screen.

Advantageously, in order to facilitate the mechanical coupling with the LED, the optical guide can have, at the base of the branch towards the LED, a gasket with the function of mechanical decoupler.

In order to have an exact correspondence between the base of the optical guide and the image generated on the screen, the configuration of the portable device can define, on the screen, the exact area where to position the optical unit.

Advantageously, this process can be rendered automatic, allowing the portable device itself to know where the optical unit has been positioned. In order to do this, the touch sensor of the screens—by now present in all portable devices—can be exploited.

Advantageously, at least one material insert detectable by the touch screen is inserted on the base of the optical unit, and a conventional orientation sign is represented on the optical unit towards a pre-established side of the portable device. The configuration of the device precisely detects the coordinates of the point of contact, and since the shape and size of the unit are known, the device can know exactly in which part of the screen to represent the image precisely aligned under the optical guide.

Advantageously, this method can be used for making the process completely automatic, without using predetermined alignments. If in fact at least three different points of contact are inserted on the base of the optical unit (e.g. with circular, triangular or rectangular shape), such points detectable by the touch screen, the device provides all the information for autonomously deciding where to represent the image.

Advantageously, this method can also be used for allowing the portable device to acquire a binary identification code of the optical unit.

Indeed, if a base with more than three points of contact is advantageously used, such points detectable by the touch screen, by positioning the points on a known grid of possible points, a binary code can be obtained that is readable by the device, which for example will associate a logic 1 with the point of the known grid where it detects a contact, and a zero with the other points.

The detected code allows activating different functions on the portable device.

Advantageously, this method can be used in a system for creating complex scenarios for the user in an immediate manner.

For example, take an optical unit with 7 points of contact (the commercial touch screens now manage at least nine points of contact). If three points are dedicated to the automatic recognition of the position, 4 points remain available for an encoding. If the known grid of the possible contacts contains 24 points, by applying the calculations of combinatorial mathematics we can determine 1 from among 4845 different codes. Some of these codes can be coupled with services delivered from remote servers (as a non-limiting example, web radio, weather forecasts). The user need only abut the optical unit against the screen in order to be connected to such services in an immediate and automatic manner, and such services can use the colors diffused by the optical unit in order to underline the messages or to provide information (for example, representing the weather forecast with colors).

Advantageously, the method can be used on an even more complex system that delivers services between many users, even in real time.

By configuring groups of users on the portable devices, such users associated with the codes defined on the base of the optical unit, group services can be activated. As a non-limiting example, take an audio conference: the group participants abut the passive optical unit against the screens and are immediately placed in audio communication with each other. The colors that are represented in a three-dimensional and visible manner by any portion represent events connected to the conference: red->conference not yet started, green->conference started, flashing red->it is not your turn to speak, flashing green->now it is your turn.

### DESCRIPTION OF THE FIGURES

The invention will be described hereinbelow in a preferred and non-limiting embodiment thereof and with reference to the enclosed figures, in which:

FIG. 1: illustrates the optical unit 100 (FIG. 1A), with the two constituent functional parts shown, the base (101) and the optical guide (102), abutted against the separate portable electronic unit 200 (FIG. 1A and FIG. 1B), showing the optical coupling principle between the unit 100 and an image 206.d or a LED (FIGS. 1A and 1C). FIG. 1B details the typical components of a portable electronic unit typically usable with the optical unit 100: a flat screen 206, a touch sensor 201, a LED 202, an audio input 203, an audio output 205, a control button 204. FIG. 1C details the embodiment with two optical branches 102.d and 102.e, one intended for the screen 206 and one intended for the LED 202;

FIG. 2: illustrates the optical unit 100 in several typical and non-limiting embodiments thereof (FIGS. 1A, 1B, 1C), showing the base 101, the optical guide 102, a possible conventional and decorative sign 102.c placed on the optical guide 102, one embodiment with two optical guides 101 (FIG. 1D). FIG. 1E illustrates the band 103 for fixing the unit 100 on the separate portable electronic unit 200. FIG. 1F illustrates the fixing gripper 104 with its return elastic part 104.b and a fulcrum 104. FIG. 2G illustrates the two sections with differentiated dispersion 102.a and 102.b of the optical guide 102. FIG. 2H illustrates the parts of an image 206.d of the flat screen 206 in its parts 206.d1 and 206.d2 corresponding to the sections 102.a and 102.b of the optical guide 102;

FIG. 3: FIG. 3A shows the optical unit 100 assembled on top of a processing unit 200 by means of the band 103. FIG. 3B shows the optical unit 100 assembled on top of a processing unit 200 by means of the clip 104. FIG. 3C shows a possible explanatory and non-limiting organization of the functions on the screen 206 of the processing unit 200: the section dedicated to the upper optical unit 206.a and two touch input sections 206.b and 206.d;

FIG. 4: FIG. 4A illustrates an optical unit 100 with the optical guide 102 in its embodiment as optical mixer with two optical coupling branches, one 102.d dedicated to the image of the flat screen 206, and the other 102.e, with the optional gasket 102.f, dedicated to the rear LED 202. FIG. 4B illustrates the unit 100 in its embodiment with a material portion 101.a detectable by the touch sensor 201 and the recognizable sign 102.c of conventional alignment. FIG. 4.C illustrates the base of the optical unit 100 with at least three material portions 101.a that can be detected by the touch sensor 201. FIG. 4D illustrates an embodiment with four material portions 101.a that can be detected by the touch sensor 201;

FIG. 5: FIGS. 5A 5B and 5C illustrate the lower part of the optical unit 100 in a non-limiting embodiment example with twenty-four possible known positions, four of which occupied by material portions 101.a. FIG. 5D shows the conventional origin and the parameters usable by the processing unit 200 in order to detect the bits b1 . . . b4 of the 24 bit code of the embodiment;

FIG. 6: details the correspondence between the base of the optical unit 100 and the processing unit 200;

FIG. 7: illustrates a non-limiting embodiment example with twenty-four possible positions on the base, 4 fixed positions in order to allow the recognition of the position on the base of the unit 100 (1,5,20,24), 4 material portions usable for encoding the unit 100, the 24-bit binary code 110 detectable in the embodiment;

FIG. 8: illustrates how a processing unit 200 can follow the position of the optical unit 100 by detecting the position of the points 101.a by means of the touch sensor 201 and representing the image 206.d on the screen 206, always under the correct place of the optical unit 100;

FIG. 9: reports the embodiment of FIG. 8, showing a non-limiting example of functional organization of the screen 206 and of the touch sensor 201 of the processing unit 200: a part 206.a and 201.a dedicated to the optical unit 100, a part 206.b and 201.b dedicated to a gestural graphic input, a part 206.c and 201.c dedicated to an input on graphic keys;

FIG. 10: FIG. 10A illustrates the system 300 composed of an optical unit 100 coupled with a processing unit 200, which detects the code 110 and uses it to be connected by means of the digital network 304 to a digital service delivered by a remote server 301. FIG. 10B illustrates the system 310 composed of two optical units 100 P1 and P2 coupled with two processing units 200 M1 and M2, which detect the two codes C1 and C2, 110.1 and 110.2 and which associate them with the two groups G1 and G2, 313.1 and 313.2, created within the lists of users L1 and L2, 313.1 and 312.2, and use all this information to be connected by means of a digital network 314 to a server 311 that manages the bidirectional subscription of digital services between the units M1 and M2.

### DETAILED DESCRIPTION OF THE INVENTION

Reference number 100 overall indicates a preferred and non-limiting embodiment of an optical unit for the three-dimensional emphasizing of light effects generated by a separate portable processing unit 200.

Said optical unit 100 is composed of two functional parts: a base 101 made of any material (by way of a non-limiting example: plastic, glass, metal) and at least one optical guide 102 (by way of a non-limiting example: made of plastic or vitreous material) of any form and integral with the base 101. One embodiment provides that the base 101 and the optical guide 102 are part of the same suitably molded material, which in this embodiment must also contemplate a material for the base that is able to operate as optical guide.

Said optical unit 100 is designed for being used together with a portable communication and processing unit 200, which can be any commercial device (by way of a non-limiting example a smartphone, a tablet, a convertible portable PC) or a device developed ad hoc.

In each case, the portable processing unit 200 is typically provided with the following characteristics: a flat screen 206, a touch sensor 201 placed on top of the flat screen, an LED visible light-emitting device 202 (typically placed in the opposite part with respect to the screen 206), an audio input 203, an audio output 205 and at least one electromechanical or capacitive button 204.

The optical unit 100 is designed for being optically coupled by means of the optical guide 102 with at least one of the following parts of the processing unit 200: with an image (static or animated) 206.d that the processing unit projects on the screen 206, or with the LED visible optical output 202. The optical unit 200 can be advantageously programmed for generating variable images 206.d (variable with regard to intensity and color) or for generating variable visible light intensities on the LED 202.

The base 101 in this embodiment has the task of ensuring a planar abutment between the optical unit 100 and the flat screen or the LED.

Advantageously in order to make the optical unit 100 integral with the processing unit 200, a band 103 can be used that is made of elastic or adjustable material, such band 103 being fixed on the base 101 of the optical unit 100.

Advantageously in order to make the optical unit 100 integral with the processing unit 200, a gripper 104 can also be used, provided with a fulcrum 104.a and with a return elastic part 104.b.

When the optical unit 100 is abutted on top of the portable unit 200, the optical guide 101 is optically coupled with the image 206.d of the screen 206 or with the LED 202, transmitting the light and colors towards the top part of the optical guide 101, generating a three-dimensional effect of the planar light source.

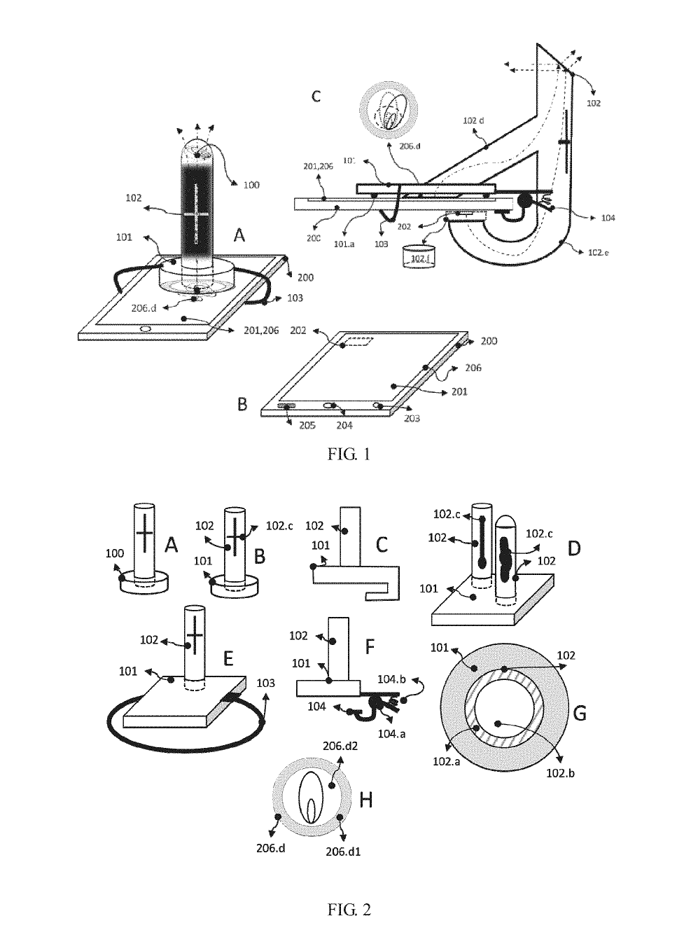

FIG. 1 shows the typical use of the optical unit 100 when coupled with a portable processing device.

FIGS. 2A, 2B, 2C, 2D, 2E and 2F show typical and non-limiting embodiments of the optical unit 100. In particular, the embodiment of FIG. 2C allows fitting the portable processing unit 200 directly on the base 101, while the embodiment of FIG. 2D shows the possibility of having two separate optical guides 102, on the same base 101, such optical guides able to be coupled with two images 206.d of the screen 206 with different intensities and colors.

On the optical unit 100 (on the base 101 or on the optical guide 102), graphic representations 102.c can be made that are excavated in the optical guide 102 or overprinted, which in addition to having a decorative or explanatory function can represent a conventional orientation sign of the unit 100 when placed on the flat screen 206.

Advantageously, in order to be able to differentiate the light effect transmitted by the optical guide 102, it is possible to have, on the base of said optical guide, at least zones with differentiated optical dispersion, such zones able to create a differentiated diffusion of the light effect. FIG. 2G details the base of the optical guide 102 with one external high dispersion zone 102.a and one internal minimal optical dispersion zone 102.b. In this manner, as detailed in FIG. 2H, the part of the image 206.d that is more external 206.d1 will generate a diffused light, dispersed within the optical guide 102 (which thus will also tend to vary the lateral surface of the optical guide 102), while the innermost part of the image 206.d1 will be mainly transmitted towards the upper part of the optical guide 102. Thus, differentiated vertical effects can be created: for example, it is possible to have a “candle” effect where the outermost part of the image 206.d1 colors and varies the body of the candle, while the central part of the image 206.d2 will be represented in the upper part of the optical guide 102.

Of course, this optical mixing effect can also be attained between an image 206.d projected on the flat screen 206 and modulated visible light generated by the LED 202.

Advantageously the embodiment detailed in FIG. 4A comprises an optical guide 102 with two divergent differentiated optical coupling branches, one branch 102.d towards the flat screen 206 and one branch 102.e towards the LED 202.

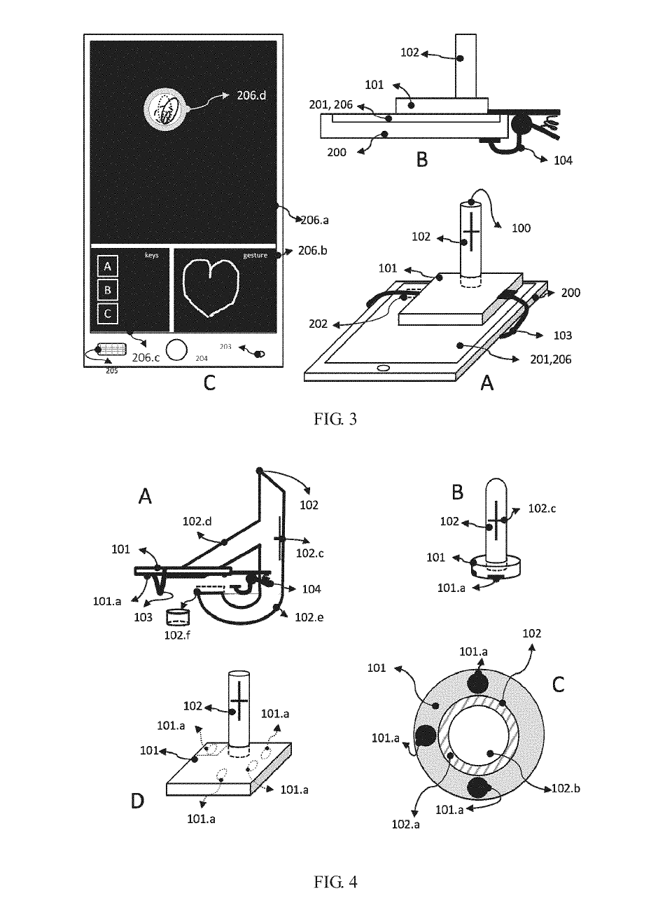

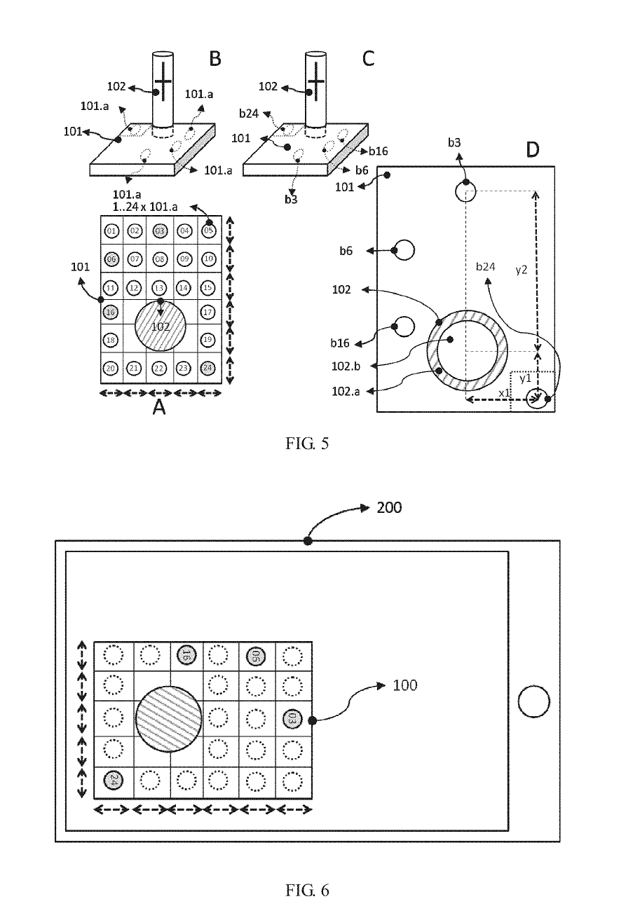

Advantageously, in order to facilitate the optical-mechanical coupling with the LED 202, the final part of the branch 102.e can be provided with a partially elastic hollow gasket 102.f. It is obvious that in order to generate the image 206.d on the flat screen 206, the processing unit must know where the optical unit 100 is abutted. In order to do this, the processing unit 200 can design a specific zone on the screen, against which the user must abut the optical unit 100 (FIGS. 3A, 3B and 3C show a possible organization of the screen and how the system that comprises the unit 100 and the device 200 appears when assembled).

FIG. 4B describes an embodiment of the unit 100 that allows automating, by means of the touch sensor 201, the recognition of the position of the optical unit 100 on the screen 206.

Advantageously, such embodiment provides that the base 101 of the optical unit 100 has at least one material insert 101.a adapted to be detected by the touch sensor. Such insert 101.a, if advantageously coupled with a conventional orientation sign 102.c, allows the processing unit 200 to know where it must present the image 206.d on the screen 206, in order to ensure that such image corresponds as mechanical alignment with the base of the optical guide 102 (of known mechanical form), the processing unit 200 being able to detect the relative coordinates with respect to an origin, conventionally selected from the configuration, of the point of contact between the material (101.a) and the touch sensor (201).

Advantageously FIG. 4C describes an embodiment of the unit 100 that provides for the presence of at least three material inserts 102.a detectable by the processing unit 200 by means of the touch sensor 201. The three material portions 102.a, suitably placed in known positions, uniquely define the position of a known geometric shape detectable by the processing unit 200 (in FIG. 4C, it is clear that three points selected on the circumference of the base 101 define only one possible circumference and only one orientation). The processing unit (200) is configured for detecting the coordinates relative to an origin, conventionally selected from the configuration, of each of the points of contact between the materials 101.a and the touch sensor 201, and hence can, with the known information and the detected positions, exactly determine the relative position of the optical unit 100 and generate an image 206.d on the screen 206 at the lower part of the optical guide 102. In this embodiment, therefore, it is not necessary to arrange any conventional sign of orientation and position for the user.

FIG. 1C details an embodiment that includes all the previously-described advantages of the optical unit 100.

Advantageously there can be more than three material portions 101.a positionable on the base 101, see FIG. 4D, without creating problems for the processing unit 200 (those currently sold in the form of a smartphone or tablet easily and simultaneously manage at least 9 points of contact on the touch sensor). The embodiment of the unit 100 can thus advantageously have N material portions 101.a (N being greater than three), placed in N positions of the base 101, such positions being selected from among M possible known positions (M being greater than or equal to N). The processing device 200 is configured for detecting the coordinates relative to an origin, conventionally selected from its configuration, of each of the points of contact between the materials 101.a and the touch sensor 201, and then can by means of the configuration, the known information and the detected coordinates not only generate an image 206.d on the screen 206 at the lower part of the optical guide 102, but also determine a unique identification code 110 of the optical unit 100. Indeed it will suffice that the processing unit, knowing beforehand the coordinates of the M possible positions, associates a binary 1 with the positions where it detects the material 101.a and a binary 0 with the others.

FIGS. 5A, 5B, 5C and 5D show the base of an optical unit 100 with 4 points of material 101.a positioned on a known grid of 24 points, their association with bits of a 24-bit binary code and the information through which the processing unit 200 can determine the exact position of the optical guide 102. FIGS. 8A and 8B show that with these known points, the processing unit 200 can follow the base of the optical guide 102.

Even by using a processing unit 200 with a limited number of detectable points of contact, thousands of possible codes can be obtained (even dedicating some bits not for the encoding but for detecting the mechanical position of the unit 100).

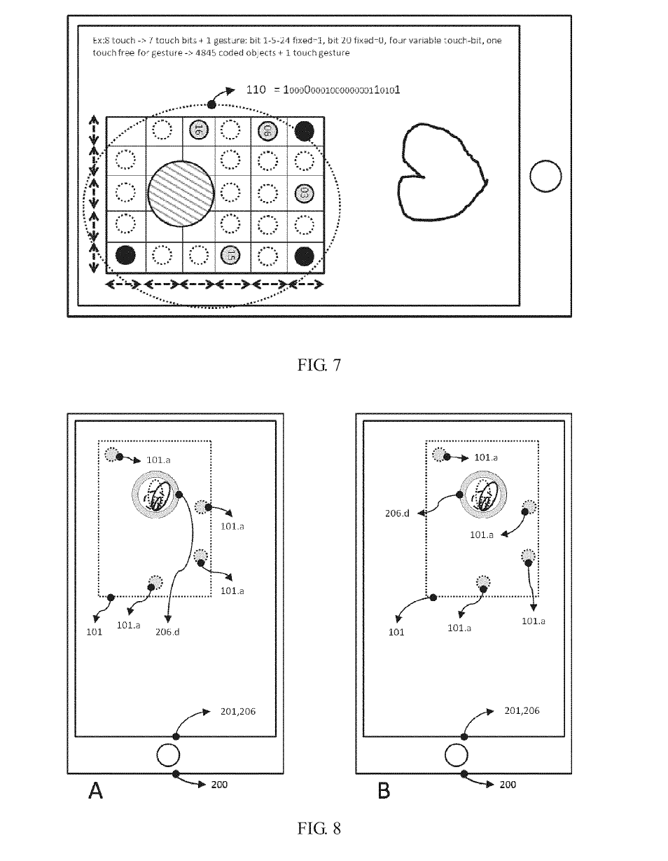

FIG. 7 reports a clarifying example: a unit 100 with a rectangular base 101, with M=24 possible known positions, with N=7 points of contact 101.a. In this case, the points placed at the positions 1,5 and 24 are forced to have a point of contact 101.a, the position 20 is forced to NOT have any point of contact. With these 4 bits (1,5,20 and 24), the position and the orientation of the unit 100 are uniquely identified. Having used only 3 of 7 points of contact, it is possible to use the remaining 4 for generating a variable unique identification code, by positioning them on the M-4 positions that have remained free. Even with only 4 remaining points, it is possible to have 4845 different codes. Such calculation is easily deduced from the known laws of combinatorial mathematics, where all the permutations with repetition of binary codes with 0,1,2,3,4 “ones” on a 20-bit word are added up (which in fact equals 4845).

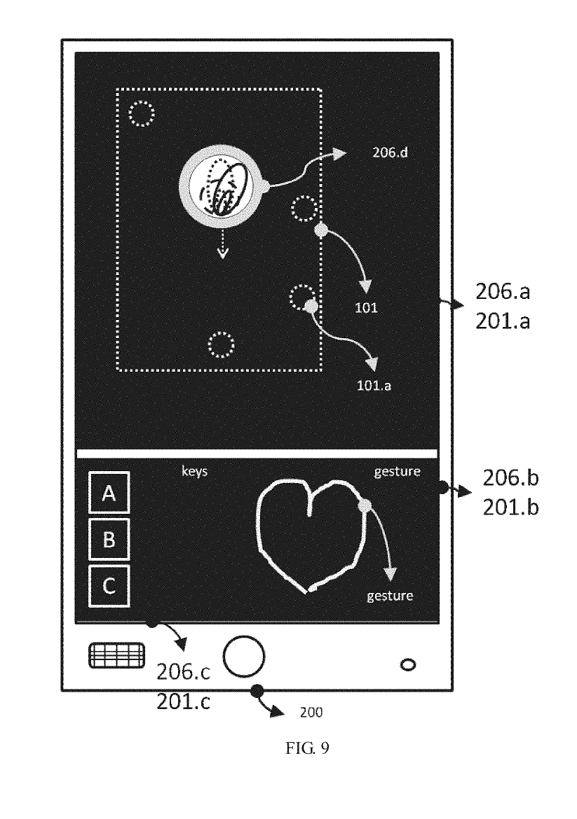

If the processing device 200 can detect 9 points of contact on the sensor 201, two further points of contact remain for the application part: for example, one can be used for detecting a conventional sign and one dedicated to keys represented on the screen (such embodiment is described in FIG. 9).

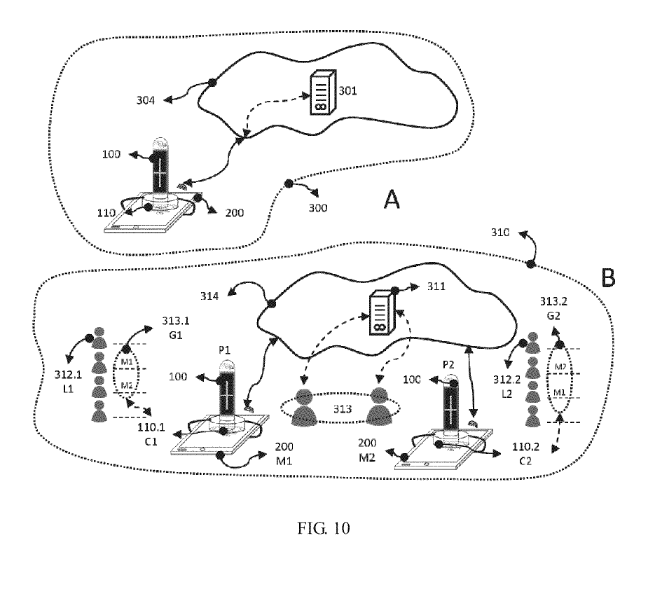

The suitably configured processing unit 200 can then determine a binary code associated with the unit 100 provided with a number N greater than 3 points of contact 101.a, simply by abutting said unit 100 against the touch sensor 201 placed on top of the flat screen 206 of the same processing unit 200. Said unit can be suitably configured in order to store in the memory a series of operations coupled with the codes of the optical unit 100, said operations able to be simply activated by abutting the optical unit 100 against the screen of the unit 100. Advantageously the optical unit 100 provided with M greater than three points of contact can be used on a system 300, illustrated in FIG. 10A, said system 300 comprising: at least one digital telecommunication network 304, at least one server 301 connected to the digital network 304, at least one processing unit 200 which has the capacity to be connected to the digital network 304, at least one optical unit 100 provided with a number N greater than 3 points of contact 101.a.

The suitably configured processing unit 200 can determine the identification code 110 encoded from the points of contact 101.a on the base 101 of the unit 100, when the unit 100 is abutted against the touch sensor 201 placed on top of the screen 106. The processing unit 200 compares the detected code with a list of stored codes, and from such list it determines all the parameters and permissions in order to be connected to a digital service delivered by the server 301, such server 301 able to have a list of services associated with each code.

One example of the system 300 is the following: a unit 100 with the embodiment of FIG. 2D has two optical guides 102, on the base 101. On one optical guide, a graphic symbol 102.c is reported, representing a thermometer, and on the other optical guide a graphic symbol 102.c is reported representing clouds.

The points of contact 101.a on the base 101 encode a code 110 which the processing unit 200, by means of the stored list and its configuration, associates with a unit 100 developed for a weather forecast service. When the user abuts the unit 100 against the flat screen 106 which has the touch sensor 101 superimposed, the processing unit 200 reads the code 110, is connected by means of the digital network 304 to the remote server 301 that delivers the weather forecast service for the zone where the unit 200 is connecting from, periodically reads the forecasts, and projects under the optical guides 102 the suitable iridescent color representations 206.d, which represent the forecast temperature and sky conditions. The rest of the flat screen can remain black. The user will only see the three-dimensional output of the images diffused by the optical guides 102.

Advantageously, the unit 100 provided with M points of contact (with M greater than three) can be used on a system 310, illustrated in FIG. 10B, said system 300 comprising: at least one digital telecommunication network 314, at least one server 311 connected to the digital network 314, at least two processing units 200 which will be indicated hereinbelow M1 and M2, which have the capacity to be connected to the digital network 314, at least two optical units 100 which will be indicated hereinbelow P1 and P2 provided with a number N greater than 3 points of contact 101.a.

The two optical units P1 and P2 each have a code 110 encoded in the base by means of the points 101.a. Hereinbelow, C1 will indicate the code 110.1 of P1 and C2 will indicate the code 110.2 of P2.

The two processing units M1 and M2 each have at least one stored list of users 312, hereinbelow indicated as L1 312.1 that of M1 and L2 312.2 that of M2. Such lists are functionally associable with other processing units 200 and include at least the users associated with the processing units M1 and M2.

The two processing units M1 and M2 also have a specific configuration capable of defining and storing a functional group of users 313 belonging to the lists 312, in each of these. Hereinbelow, G1 will indicate the group of users 313.1 belonging to the list L1 of the processing unit M1, and G2 will indicate the group of users 313.2 belonging to the list L2 of the processing unit M2. G1 will include at least M1 and M2, and G2 will include at least M2 and M1.

The two processing units M1 and M2 also have a configuration capable of associating the groups G1 and G2 with the codes C1 and C2 of the units P1 and P2. M1 associates C1 with the group G1 when the user abuts the unit P1 against the screen of M1, and analogously M2 associates C2 with the group G2 when the user abuts the unit P2 against the screen of M2. The two processing units M1 and M2 also have a specific configuration that permits: M1, when it detects the code C1 of P1, to be connected by means of the network 314 to a server 311 by establishing a connectivity of digital services with the processing units 200 associated with the group G1 (group that also includes the unit M2). Analogously, the configuration of M2 allows it, when it detects the code C2 of P2, to be connected by means of the network 314 to a server 311 by establishing a connectivity of digital services with the processing units 200 associated with the group G2 (group that also includes the unit M1).

In this manner, simply by abutting the units P1 and P2 against the screens of M1 and M2, a complex bidirectional digital service is activated between processing units.

An explanatory and non-limiting example with at least two users is the following: people form a prayer group, by associating such group with all the people who wish to pray together. Each person belonging to the group possesses an optical unit 100 in the embodiment of FIG. 1C, with an identification encoded in the base 101. As the prayer time is approaching, all those who wish to participate abut the optical unit 100 (which has the shape of a votive candle) against the screen of their smartphones or their tablets. Automatically, all the devices are connected to the remote audio conference server, and they remain in standby. The color of the (candle-shaped) optical unit is RED to indicate that the prayer session has not started. When the prayer session starts, all the units become GREEN and the remote server places all the users in audio conference. During the prayer session, the white light of the LED is activated. As soon as a user removes his/her optical unit from atop the screen, he/she is disconnected from the prayer session.

It is clear that by means of the system 310, there is no predetermined limit to the number of users that can be simultaneously optically connected by means of the optical units 100.

Finally, it is clear that additions, modifications or variations that are obvious for a man skilled in the art can be made to the optical system and unit that are the object of the present invention, without departing from the protective scope provided by the enclosed claims.

1. System (300) comprising: at least one digital network (304), at least one server (301) connected to said digital network (304), at least one optical unit (100), at least one portable electronic processing unit (200) having the capacity to be connected to said digital network (304), wherein said optical unit (100) comprises: at least one base (101) made of any one material; and at least one optical guide (102) made of plastic or vitreous material and the like of any shape and integral with said base (101), said unit (100) having the capacity to be optically coupled with at least one image (206.d) generated on the flat screen (206) of said separate portable electronic unit (200), and the capacity to be optically coupled with an LED (202) of said separate portable electronic unit (200) suitably configured for generating light intensity variations of said LED (202), said optical unit (100) also comprising a band (103) adapted to make the optical unit (100) integral with the portable electronic processing unit (200), said optical unit (100) having, on the base of the optical guide (102), at least two zones with different optical dispersion (102.a and 102.b) adapted to be optically coupled together in a differentiated manner with an image (206.d) presented on the flat screen (206) of the portable electronic processing unit (200), said optical unit (100) comprising two different optical coupling branches, said branches being one branch (102.d) towards the flat screen (206) and one branch (102.e) towards the LED (202), both converging on the same optical guide (102), with the function of optical mixing between an image (206.d) generated by the flat screen (206) and a visible light radiation generated by the LED (202), said optical unit (100) having, at the base of the branch (102.e) towards the LED (202), a gasket (102.f) adapted to absorb the mechanical pressure of such branch (102.e) on the zone around the LED (202).

2. System (300) according to claim 1, the optical unit (100) comprises a recognizable sign (102.c) of conventional alignment, said sign being arranged on the base (101) or on the optical guide (102) and comprises, on the lower part of the base (101), at least one material portion (101.a) adapted to be detected by the touch sensor (201) placed on top of the flat screen (206) of the processing unit (200) when the optical unit (100) is abutted against said touch sensor (201), said processing unit (200) being configured for detecting the coordinates relative to an origin, conventionally selected from the configuration, of the point of contact between the material (101.a) and the touch sensor (201), said processing unit (200) able, by means of the configuration, the known information and the detected positions, to determine the relative position of the optical unit (100) and generate an image (206.d) on the screen (206) at the lower part of the optical guide (102).

3. System (300) according to claim 1, wherein the optical unit (100) is provided, on the lower part of the base (101), with at least three material portions (101.a) placed in a known position of the same base (101) and adapted to be detected by the touch sensor (201) placed on top of the flat screen (206) of the processing unit (200), said processing unit (200) being configured to detect the coordinates relative to an origin, conventionally selected from the configuration, of the points of contact between the material (101.a) and the touch sensor (201), said processing unit (200) able, by means of the configuration, the known information and the detected positions, to determine the relative position of the optical unit (100) and generate an image (206.d) on the screen (206) at the lower part of the optical guide (102).

4. System (300) according to claim 1, wherein the optical unit (100) is provided, on the lower part of the base (101), with a number N, with N greater than three, material portions (101.a) arranged at positions of the same base (101) selected from among M possible known positions, with M greater than or equal to N, adapted to be detected by the touch sensor (201) placed on top of the flat screen (206) of the processing unit (200) when the optical unit (100) is abutted against the touch sensor (201), said processing unit (200) being configured for detecting the coordinates relative to an origin, conventionally selected from the configuration, of each of the points of contact between the materials (101.a) and the touch sensor (201), the processing unit (200) able, by means of the configuration, the known information and the detected coordinates, to also determine an identification code (110) of the optical unit (100) encoded from the points of material (101.a) and activate different operations stored in the unit (200) from the configuration, such operations being selected based on the previously-determined identification code of the optical unit (100).

5. System (300) according to claim 4, further comprising two optical units (100) and two processing units (200) connectable to the digital network, said system also comprising at least two lists of users (312), such lists being functionally associable with said processing units (200) and including at least the users associated with said two processing units, said system also allowing the storage of at least two functional groups (313) of users, said users being at least those associated with said two processing units (200), said system allowing the association of each of said functional groups (313) of users belonging to said lists (312) with a corresponding code (110), detectable when the corresponding optical unit (100) is placed on top of the touch sensor (201) of the corresponding processing unit, said system allowing the establishment, by means of at least one server, of a connectivity of digital services with each of said electronic units (200).

6. System (300) according to claim 1, further comprising a gripper (104) adapted to make the optical unit (100) integral with the portable electronic processing unit (200).

7. Optical unit (100) having the characteristics of the optical unit (100) of the system (300) according to claim 1, said optical unit (100) comprising: at least one base (101) made of any one material; and at least one optical guide (102) in plastic or vitreous material and the like of any shape and integral with said base (101), said unit (100) having the capacity to be optically coupled with at least one image (206.d) generated on the flat screen (206) of a separate portable electronic processing unit (200), and the capacity to be optically coupled with a LED (202) of said separate portable electronic processing unit (200) suitably configured for generating light intensity variations of said LED (202), said optical unit (100) also comprising a band (103) adapted to make the optical unit (100) integral with the portable electronic processing unit (200), said optical unit (100) having, on the base of the optical guide (102), at least two zones with different optical dispersion (102.a and 102.b) adapted to be optically coupled in a differentiated manner with an image (206.d) presented on the flat screen (206) of the portable electronic processing unit (200), said optical unit (100) comprising at least two different optical coupling branches, said branches being one branch (102.d) towards the flat screen (206) and one branch (102.e) towards the LED (202), both converging on the same optical guide (102), with the function of optical mixing between an image (206.d) generated by the flat screen (206) and a visible light radiation generated by the LED (202), said optical unit (100) having, at the base of the branch (102.e) towards the LED (202), a gasket (102.f) adapted to absorb the mechanical pressure of such branch (102.e) on the zone around the LED (202).

8. Optical unit (100) according to claim 7, further comprising a recognizable sign (102.c) of conventional alignment, said sign being arranged on the base (101) or on the optical guide (102), said optical unit (100) comprising, on the lower part of the base (101), at least one material portion (101.a) adapted to be detected, by the touch sensor (201) placed on top of the flat screen (206) of the processing unit (200), when the optical unit (100) is abutted against said touch sensor (201), said processing unit (200) being configured for detecting the coordinates relative to an origin, conventionally selected from the configuration, of the point of contact between the material (101.a) and the touch sensor (201), said processing unit (200) able, by means of the configuration, the known information and the detected positions, to determine the relative position of the optical unit (100) and generate an image (206.d) on the screen (206) at the lower part of the optical guide (102).

9. Optical unit (100) according to the claim 8, provided, on the lower part of the base (101), with at least three material portions (101.a) arranged at known positions of the same base (101) and adapted to be detected by the touch sensor (201) placed on top of the flat screen (206) of the processing unit (200).

10. A portable device capable of displaying three-dimensional luminous messages comprising the optical unit (100) according to claim 7.

11. The system of claim 1, wherein the any one material is selected from the group consisting of plastic, glass, and metal.

12. The optical unit of claim 7, wherein the any one material is selected from the group consisting of plastic, glass, and metal.

13. System (300) according to claim 2, further comprising a gripper (104) adapted to make the optical unit (100) integral with the portable electronic processing unit (200).

14. System (300) according to claim 3, further comprising a gripper (104) adapted to make the optical unit (100) integral with the portable electronic processing unit (200).

15. System (300) according to claim 4, further comprising a gripper (104) adapted to make the optical unit (100) integral with the portable electronic processing unit (200).

16. System (300) according to claim 5, further comprising a gripper (104) adapted to make the optical unit (100) integral with the portable electronic processing unit (200).

17. Optical unit (100) having the characteristics of the optical unit (100) of the system (300) according to claim 2, said optical unit (100) comprising: at least one base (101) made of any one material; and at least one optical guide (102) in plastic or vitreous material and the like of any shape and integral with said base (101), said unit (100) having the capacity to be optically coupled with at least one image (206.d) generated on the flat screen (206) of a separate portable electronic processing unit (200), and the capacity to be optically coupled with a LED (202) of said separate portable electronic processing unit (200) suitably configured for generating light intensity variations of said LED (202), said optical unit (100) also comprising a band (103) adapted to make the optical unit (100) integral with the portable electronic processing unit (200), said optical unit (100) having, on the base of the optical guide (102), at least two zones with different optical dispersion (102.a and 102.b) adapted to be optically coupled in a differentiated manner with an image (206.d) presented on the flat screen (206) of the portable electronic processing unit (200), said optical unit (100) comprising at least two different optical coupling branches, said branches being one branch (102.d) towards the flat screen (206) and one branch (102.e) towards the LED (202), both converging on the same optical guide (102), with the function of optical mixing between an image (206.d) generated by the flat screen (206) and a visible light radiation generated by the LED (202), said optical unit (100) having, at the base of the branch (102.e) towards the LED (202), a gasket (102.f) adapted to absorb the mechanical pressure of such branch (102.e) on the zone around the LED (202).

18. Optical unit (100) having the characteristics of the optical unit (100) of the system (300) according to claim 3, said optical unit (100) comprising: at least one base (101) made of any one material; and at least one optical guide (102) in plastic or vitreous material and the like of any shape and integral with said base (101), said unit (100) having the capacity to be optically coupled with at least one image (206.d) generated on the flat screen (206) of a separate portable electronic processing unit (200), and the capacity to be optically coupled with a LED (202) of said separate portable electronic processing unit (200) suitably configured for generating light intensity variations of said LED (202), said optical unit (100) also comprising a band (103) adapted to make the optical unit (100) integral with the portable electronic processing unit (200), said optical unit (100) having, on the base of the optical guide (102), at least two zones with different optical dispersion (102.a and 102.b) adapted to be optically coupled in a differentiated manner with an image (206.d) presented on the flat screen (206) of the portable electronic processing unit (200), said optical unit (100) comprising at least two different optical coupling branches, said branches being one branch (102.d) towards the flat screen (206) and one branch (102.e) towards the LED (202), both converging on the same optical guide (102), with the function of optical mixing between an image (206.d) generated by the flat screen (206) and a visible light radiation generated by the LED (202), said optical unit (100) having, at the base of the branch (102.e) towards the LED (202), a gasket (102.f) adapted to absorb the mechanical pressure of such branch (102.e) on the zone around the LED (202).

19. Optical unit (100) having the characteristics of the optical unit (100) of the system (300) according to claim 4, said optical unit (100) comprising: at least one base (101) made of any one material; and at least one optical guide (102) in plastic or vitreous material and the like of any shape and integral with said base (101), said unit (100) having the capacity to be optically coupled with at least one image (206.d) generated on the flat screen (206) of a separate portable electronic processing unit (200), and the capacity to be optically coupled with a LED (202) of said separate portable electronic processing unit (200) suitably configured for generating light intensity variations of said LED (202), said optical unit (100) also comprising a band (103) adapted to make the optical unit (100) integral with the portable electronic processing unit (200), said optical unit (100) having, on the base of the optical guide (102), at least two zones with different optical dispersion (102.a and 102.b) adapted to be optically coupled in a differentiated manner with an image (206.d) presented on the flat screen (206) of the portable electronic processing unit (200), said optical unit (100) comprising at least two different optical coupling branches, said branches being one branch (102.d) towards the flat screen (206) and one branch (102.e) towards the LED (202), both converging on the same optical guide (102), with the function of optical mixing between an image (206.d) generated by the flat screen (206) and a visible light radiation generated by the LED (202), said optical unit (100) having, at the base of the branch (102.e) towards the LED (202), a gasket (102.f) adapted to absorb the mechanical pressure of such branch (102.e) on the zone around the LED (202).

20. Optical unit (100) having the characteristics of the optical unit (100) of the system (300) according to claim 5, said optical unit (100) comprising: at least one base (101) made of any one material; and at least one optical guide (102) in plastic or vitreous material and the like of any shape and integral with said base (101), said unit (100) having the capacity to be optically coupled with at least one image (206.d) generated on the flat screen (206) of a separate portable electronic processing unit (200), and the capacity to be optically coupled with a LED (202) of said separate portable electronic processing unit (200) suitably configured for generating light intensity variations of said LED (202), said optical unit (100) also comprising a band (103) adapted to make the optical unit (100) integral with the portable electronic processing unit (200), said optical unit (100) having, on the base of the optical guide (102), at least two zones with different optical dispersion (102.a and 102.b) adapted to be optically coupled in a differentiated manner with an image (206.d) presented on the flat screen (206) of the portable electronic processing unit (200), said optical unit (100) comprising at least two different optical coupling branches, said branches being one branch (102.d) towards the flat screen (206) and one branch (102.e) towards the LED (202), both converging on the same optical guide (102), with the function of optical mixing between an image (206.d) generated by the flat screen (206) and a visible light radiation generated by the LED (202), said optical unit (100) having, at the base of the branch (102.e) towards the LED (202), a gasket (102.f) adapted to absorb the mechanical pressure of such branch (102.e) on the zone around the LED (202).
